(19) United States
(12) Patent Application Publication
(10) Pub. No.: US 2020/0156957 A1
(43) Pub. Date: May 21, 2020

(54) MEDIA EXTRACTING APPARATUS FOR A WATER TREATMENT SYSTEM TANK AND METHOD

(71) Applicant: Marlin Martin, Akron, PA (US)

(72) Inventor: Marlin Martin, Akron, PA (US)

(21) Appl. No.: 16/673,906

(22) Filed: Nov. 4, 2019

Related U.S. Application Data
(60) Provisional application No. 62/767,540, filed on Nov. 15, 2018.

(51) Int. Cl. C02F 1/00; E03B 11/06

(52) U.S. Cl. CPC C02F 1/006; E03B 11/06; C02F 2303/18; C02F 2201/004; C02F 2303/14

(57) ABSTRACT

The present invention is a media extraction apparatus for removing media from a tank of a domestic water supply. The apparatus has a connection fixture where the connection fixture is configured to be operably coupled to a service connection of a media-containing tank of a water treatment equipment. A body, extending from the connection fixture, has an interior and an inlet. The body extends from the connection fixture and the interior allows for passage of a scavenging conduit. A pressure-tight seal is connected to an exterior surface of the scavenging conduit and the inlet of body allows for the opening of an air inlet path in the media-containing tank. One end of the scavenging conduit is positioned inside of the tank and an opposite end of the scavenging conduit is positioned in a waste collection vessel.

### PRIORITY

This utility application claims the benefit of U.S. Provisional Patent Application No. 62/767,540, filed on Nov. 15, 2018, the entirety of which is hereby incorporated by reference.

### FIELD OF THE INVENTION

This invention relates generally to the field of residential water treatment systems and, more particularly, to an apparatus and improved method for extracting water treatment media from a tank in a water treatment apparatus.

### BACKGROUND

Water treatment systems are commonly used in residential and commercial domestic water supplies to filter or otherwise manage impurities contained in the incoming water, whether from public water supplies or individual wells. Such systems may be used to remove hardness, manage the pH level, or remove other impurities in the water prior to its use in a home or business. Most such systems require passing a flow of untreated water through a bed of media material in which filtering, ion exchange, or other chemical alteration occurs.

In some systems, the media may be periodically rejuvenated, such as the case with ion-exchange water softening. In others, media removal and replacement may be necessary to maintain function of the water treatment system, such as the case of calcite pH treatment or activated carbon filtering systems.

Replacing the media in a water treatment system tank first requires removing the old media and then refilling the tank with new filtering or treatment media. As the tank are typically connected to a domestic water supply system, breaching the tank requires isolating the tank from the domestic water system and accessing the tank to remove the spent media. The most common approach is to use a shop vacuum with a long, thin suction hose inserted through an access port in the treatment system tank. Limited suction capability of typical vacuums may limit the amount of spent media that can be recovered from the tank. Further the process is cumbersome, time consuming, and easily results in spillage of water and/or media in the area around the water treatment system equipment. An apparatus and method for removing spent media from a tank in a water treatment system that addresses these limitations would be advantageous.

### SUMMARY OF THE INVENTION

Accordingly, the present invention, in any of the embodiments described herein, may provide one or more of the following advantages:

It is an object of the present invention to provide a media extraction apparatus which may be connected to a media containing tank in a water treatment system and a method for operating the fixture enabling the media to be removed from the tank using the domestic water supply to which the water treatment system is connected. The apparatus includes a connection fixture adapted to be operably connected to a service connection near the top of the tank while the tank is isolated from the domestic water supply and the tank depressurized. A scavenging conduit passes through a pressure-tight seal in the tank connection fixture. One end of the scavenging conduit is positioned inside the tank while the opposite end is directed to a waste collection vessel. When the tank is reconnected to the domestic water supply, water pressure drives the spent media through the scavenging conduit where it is collected in the waste collection vessel. The scavenging conduit is sufficiently flexible to enable it to be moved within the tank and maximize the amount of the media that may be removed.

Once the media is removed, the domestic water supply is isolated from the treatment system tank to suspend discharge to the waste collection vessel.

It is a further object of the present invention to provide a media extraction apparatus for use on a media containing tank in a water treatment system that is adaptable to service connections existing on the treatment system tank. To this end, the apparatus includes a connection fixture enabling the apparatus to be hydraulically connected to the tank. Adapters may be provided to allow the fixture to be connected to different-sized tank service connection openings.

It is a still further object of the present invention to provide a media extraction apparatus for a treatment tank in a water treatment system that includes a flexible portion which allows the orientation of the body and scavenging conduit to be altered in relation to the water treatment system tank. The exemplar flexible portion is formed from a conventional rubber coupling connecting the relatively rigid fixture and the remainder of the body.

It is a still further object of the present invention to provide a media extraction apparatus for a treatment tank in a water treatment system that includes a vacuum relief port provided in the apparatus that may then be opened once the media is extracted allowing water remaining in the tank to be siphoned out and into the waste collection vessel to prevent overflow when the new media is added to the tank.

It is a still further object of the present invention to provide a media extraction apparatus for a treatment tank in a water treatment system that includes female hose threads on the afore mentioned vacuum relief port which can be used as an alternate source of water in the event that a connection to the home or buildings plumbing is not available.

It is a still further object of the present invention to provide a media extraction apparatus for a treatment tank in a water treatment system that is durable in construction, inexpensive of manufacture, carefree of maintenance, easily assembled, and simple and effective to use.

These and other objects are achieved in accordance with the present invention by providing a media extraction apparatus which may be connected to a media containing vessel in a water treatment system and a method for operating the fixture enabling the spent media to be removed from the tank using the domestic water supply to which the treatment system is connected. The apparatus includes a connection fixture adapted to be operably connected to a service connection near the top of the tank while the tank is isolated from the domestic water supply and the tank depressurized. Adapters may be provided to allow the fixture to be connected to different-sized tank service connection openings. A scavenging conduit passes through a pressure-tight seal in the tank connection fixture. One end of the scavenging conduit vessel. When the tank is reconnected to the domestic water supply, water pressure drives the spent media from the tank through the scavenging conduit where it is collected in the waste collection vessel. The scavenging conduit is sufficiently flexible to enable it to be moved within the tank and maximize the amount of the media that may be removed. Once the media is removed, the domestic water supply is isolated from the tank to suspend discharge to the waste collection vessel. A vacuum relief port provided in the apparatus that may then be opened once the media is extracted allowing water remaining in the tank to be siphoned out and into the waste collection vessel. Removing at least a portion of the water from the tank is necessary to prevent water overflow when the new water treatment media is added to the tank.

### BRIEF DESCRIPTION OF THE DRAWINGS

The advantages of this invention will be apparent upon consideration of the following detailed disclosure of the invention, especially when taken in conjunction with the accompanying drawings wherein:

FIG. 1 provides a diagrammatic illustration of a portion of a conventional water treatment system having a treatment tank with the present invention configured as it would be for use; and;

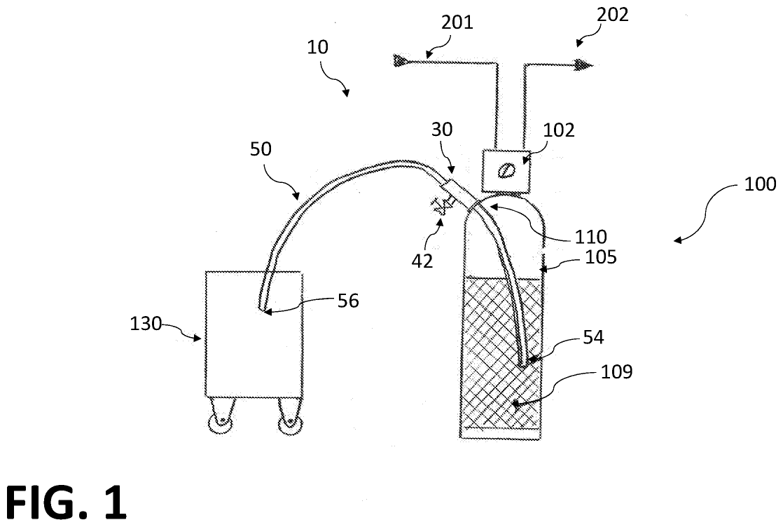

FIG. 2 illustrates the configuration of the media extraction apparatus of the present invention.

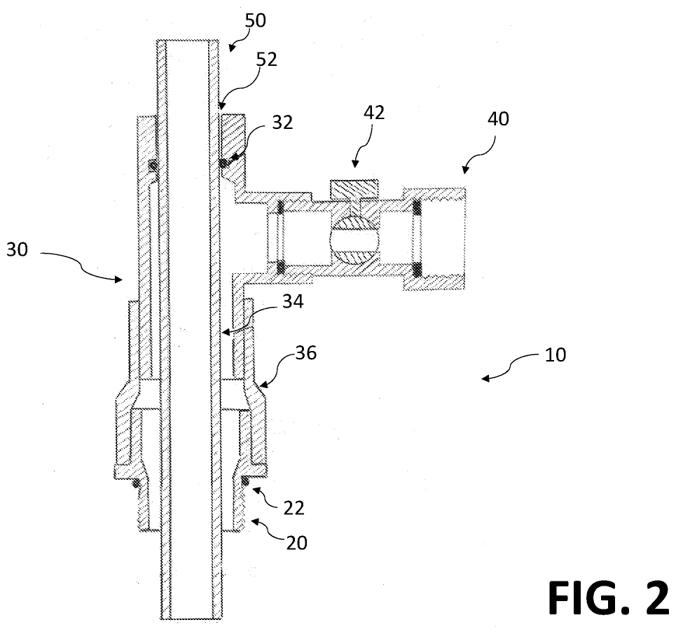

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

All illustrations of the drawings are for the purpose of describing selected versions of the present invention and are not intended to limit the scope of the present invention.

Many of the fastening, connection, processes and other means and components utilized in this invention are widely known and used in the field of the invention described, and their exact nature or type is not necessary for an understanding and use of the invention by a person skilled in the art, and they will not therefore be discussed in significant detail. Also, any reference herein to the terms “up” or “down,” or “top” or “bottom” are used as a matter of mere convenience and are determined with reference to a floor or the ground.

Furthermore, the various components shown or described herein for any specific application of this invention can be varied or altered as anticipated by this invention and the practice of a specific application of any element may already be widely known or used in the art by persons skilled in the art and each will likewise not therefore be discussed in significant detail. When referring to the figures, like parts are numbered the same in all figures.

Referring to the figures, the media extracting apparatus 10 comprises a connection fixture 20 adapted to be operably connected to a service connection 110 provided on the media-containing tank 105 of the water treatment equipment 100. The connection fixture 20 is sealed retaining to prevent spillage of water from the treatment equipment. The fixture 20 may be provided with conventionally size plumbing connections, such as threads, to mate with standard connections available on the tank. In the exemplar embodiment, the connection fixture includes 1¼ inch male pipe threads configured to interface with the same-sized female pipe thread opening provided on the service connection 110. Conventional plumbing adapters may be provided to permit connection of the fixture 20 to other opening sizes that may exist on the water treatment equipment. The connection between the fixture 20 and the tank service opening 110 may be provided with an O-ring seal 22 to provide a watertight connection to the water treatment equipment. Other known plumbing sealing techniques are also contemplated.

The media extraction apparatus 10 further includes a body 30 extending from the connection fixture 20. The body 30 has a generally hollow interior 34 sized to permit passage of a scavenging conduit 50 therethrough. A pressure-tight seal 32 is provided to prevents leakage around the interface with the exterior surface 52 of the conduit 50. The seal 32 further permits axial movement of the scavenging conduit 50 in relation to the extraction apparatus 10.

In the exemplar embodiment illustrated, the scavenging conduit 50 is a length of ¾-inch flexible tubing, such as commercially available PEX, of sufficient length to extend into the bottom of the tank 105 and to a collection vessel 130 positioned proximate to the water treatment equipment 100.

The body 30 further includes an inlet 40 enabling a user to selectively open an air inlet path into the tank 105 via the exchange apparatus 10 for relieving pressure within the tank or allow air to be admitted so that water within the tank 105 may be removed via the scavenging conduit 50. The inlet 40 is preferably provided with a user-controllable valve 42, such as a ball valve.

When the valve is closed, the body 30 retains pressure communicating with the internal pressure of the tank 105. Opening the valve 42 permits air to enter the tank 105 through the exchange apparatus 10 provided the tank 105 has been isolated from the water supply pressure.

The inlet 40 may also include female hose threads that could be used as an alternate source of water in the event that a domestic water supply is not available to be connected to the tank 105 at the time the extraction device is being used. In this case a commonly available garden hose can be connected to the inlet 40 and the valve 42 opened to provide water flow to propel the spent media through the scavenging conduit 50 and into the collection vessel 130.

The body 30 may also include a flexible portion 36 which allows the orientation of the body 30 and scavenging conduit 50 to be altered in relation to the water treatment system tank 105. The exemplar flexible portion 36 is formed from a conventional rubber coupling connecting the relatively rigid fixture 20 and the remainder of the body 30.

The scavenging conduit 50 is sufficiently flexible to enable it to be moved within the tank 105 and maximize the amount of the media that may be removed. Providing flexibility in the scavenging conduit also allows insertion into smaller diameter tanks or tanks on which the service connection 110 is angled in relation to the major axis of the tank (e.g., a small diameter vertical cylinder). In the exemplar embodiment, the scavenger conduit 50 is a section of ¾-inch PEX pipe.

The method of using the media extraction apparatus 10 relies on the domestic water supply and pressure available in the water treatment system for motive force to remove spent media 109 from the media-containing tank 105. In a conventional arrangement, the water treatment equipment is connected to the domestic water supply. A mode control 102 is typically available to manage operation of the water treatment equipment as well as bypass the equipment for maintenance or replacement. There are numerous ways in which this control occurs. For the illustrative purposes of this disclosure, the mode control 102 may comprise a single actuator or a combination of actuators arranged to align the treatment equipment 100 as described.

The media is typically in the form of a granules, spherical pellets, crystals, or similar solid form material. When placed in a tank or other container, the size and configuration of the media creates open areas between adjacent particles though which water may pass. Such media typically has a density greater than that of water so that it sits in the bottom of the treatment system tank rather than floating on the surface.

The water treatment equipment is realigned using the mode control 102 so that water pressure from the domestic water supply 201 is isolated from the ion exchange tank 105. This allows the service connection 110 to be opened without discharging pressurized water through the opening. The media extraction apparatus 10 is attached to the service connection 110 by sealingly securing the connection fixture 20 to the now open service connection 110. The scavenging conduit 50 is moved axially to position the inlet opening 54 inside the tank 105. The discharge opening 56 of the scavenging conduit 50 is positioned in a waste collection vessel 60 or the like. The valve 42 controlling inlet 40 is confirmed to be closed.

The water treatment equipment 100 is realigned so that the domesticator supply 201 is directed to the media-containing tank 105, but the treated water outlet 202 is isolated. In conventional water treatment systems, this may be achieved by placing the equipment into a backwash mode. Water entering the tank 105 is directed out through the scavenging conduit 50 to the waste collection vessel 60, carrying with it the media in the tank. The scavenging conduit 50 may be moved by the user, whether axially to extend the projection into the tank or by reorienting using the flexible portion 36, to facilitate entrainment of media 109 within the tank into the flow stream discharging through the scavenging conduit 50. This process is allowed to continue until substantially all of the spent media 109 is extracted from the tank 105.

Realigning the water treatment equipment to a bypass mode stops the flow of water into the tank.

Once the spent media 109 has been removed from the tank and the water supply isolated, the user may open the valve 42 controlling inlet 40. This action allows air to enter the tank 105, and water contained in the tank to be drained or siphoned to the waste collection vessel 60 via the scavengingconduit 50. Removal of at least a portion of the water remaining in the tank 105 is necessary to provide volume for the replacement media to be added to the media-containing tank. Upon removal of a sufficient volume of water from the tank 105 to permit replenishment of the media, the scavenging conduit 50 is preferably pulled axially through the apparatus, breaking the fluid flow when the inlet opening 54 rises above the fluid level. The media extraction apparatus may then be removed from the tank 105. New media may be added through the service connection 110. Once replenishment of the media is complete, the service connection 110 is closed (plug is reinstalled) and the water treatment equipment 100 returned to an operating state. Waste media and water contained in the collection vessel 60 may be disposed.

Naturally, the invention is not limited to the foregoing embodiments, but it can also be modified in many ways without departing from the basic concepts. Changes in the details, materials, steps and arrangements of parts which have been described and illustrated to explain the nature of the invention will occur to and may be made by those skilled in the art upon a reading of this disclosure within the principles and scope of the invention. The foregoing description illustrates the preferred embodiment of the invention; however, concepts, as based upon the description, may be employed in other embodiments without departing from the scope of the invention.

Although the invention has been explained in relation to its preferred embodiment it is to be understood that many other possible modifications and variations can be made without departing from the spirit and scope of the invention.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A media extraction apparatus for removing media form a tank of a domestic water supply, the apparatus comprising:
a connection fixture, the connection fixture being configured to be operably coupled to a service connection of a media-containing tank of a water treatment equipment;
a body, the body having an interior, an inlet, the body being extended from the connection fixture, and wherein the interior being for passage of a scavenging conduit;
a pressure-tight seal, the pressure-tight seal being coupled to an exterior surface of the scavenging conduit;
the inlet of the body being for opening an air inlet path in the media-containing tank;
one end of the scavenging conduit being positioned inside of the tank; and
an opposite end of the scavenging conduit being positioned in a waste collection vessel.

2. The apparatus of claim 1, wherein the connection fixer having a one and one-fourth (1.25) inch male pipe threads.

3. The apparatus of claim 1, wherein an inside of the body being hollow.

4. The apparatus of claim 1, wherein the scavenging conduit being a length of three-fourths (¾) inch flexible tubing.

5. The apparatus of claim 4, wherein the flexible tubing being PEX material.

6. The apparatus of claim 1, wherein the apparatus being hydraulically coupled to the tank.

7. The apparatus of claim 6, wherein the apparatus having adapters to being coupled to a different-sized tank connection opening.

8. The apparatus of claim 1, wherein the apparatus further comprising a vacuum relief port, the vacuum relief port being for preventing overflow when remaining water being siphoned from the tank.

9. A method of media extraction from a tank of a domestic water supply, the method comprising:
coupling a connection fixture to a service connection of a media-containing tank of a water treatment equipment;
inserting a scavenging conduit through a body of the connection fixture, wherein one end of the scavenging conduit being inside of the tank; and
an opposite end of the scavenging conduit being positioned in a waste collection vessel.

10. The method of claim 9, wherein the connection fixture having a one and one-fourth (1.25) inch male pipe threads.

11. The method of claim 9, wherein an inside of the body being hollow.

12. The method of claim 9, wherein the scavenging conduit being a length of three-fourths (¾) inch flexible tubing.

13. The method of claim 12, wherein the flexible tubing being PEX material.

14. The method of claim 9, wherein hydraulically coupling the connection fixture to the tank.

15. The method of claim 14, wherein coupling the connection adapters to to a different-sized tank connection opening.

16. The method of claim 1, wherein the method further comprising coupling a vacuum relief port to the connection fixture, opening the vacuum relief port to prevent overflow when remaining water is being siphoned from the tank.
